(19) United States
(12) Patent Application Publication
(10) Pub. No.: US 2017/0341028 A1
(43) Pub. Date: Nov. 30, 2017

(54) ULTRAFILTRATION PURIFICATION OF QUANTUM-DOTS

(71) Applicant: Shoei Chemical Inc., Tokyo (JP)

(72) Inventors: Daniel Peterson, Corvallis, OR (US); Patrick M. Haben, Corvallis, OR (US); Thomas E. Novet, Corvallis, OR (US)

(21) Appl. No.: 15/603,287

(22) Filed: May 23, 2017

Related U.S. Application Data
(60) Provisional application No. 62/342,745, filed on May 27, 2016.

(51) Int. Cl. B01D 61/14; C09K 11/70; B01D 71/34; B82Y 40/00; B82Y 20/00

(52) U.S. Cl. CPC B01D 61/145; C09K 11/703; B01D 71/34; Y10S 977/824; Y10S 977/818; Y10S 977/774; B01D 2311/25; Y10S 977/95; B82Y 20/00; B01D 2311/2676; B01D 2311/2642; Y10S 977/90; B82Y 40/00

(57) ABSTRACT

Examples are disclosed that relate to an ultrafiltration system for quantum-dot (QD) purification. The ultrafiltration system comprises a pump having a low-pressure side and a high-pressure side, a size-exclusion membrane having a low-pressure side and a high-pressure side, and an inlet/outlet arrangement. An inlet arranged on the high-pressure side of the size-exclusion membrane is coupled fluidically to the high-pressure side of the pump. A product-enriched outlet is arranged on the high-pressure side of the size-exclusion membrane, fluidically downstream of the inlet. A product-depleted outlet is arranged on the low-pressure side of the size-exclusion membrane.

### CROSS-REFERENCE TO RELATED APPLICATIONS

This application claims the benefit of U.S. Provisional Patent Application No. 62/342,745, filed May 27, 2016, and entitled “Ultrafiltration Purification of Quantum-Dots”, the complete contents of which are hereby incorporated herein by reference for all purposes.

### BACKGROUND

A quantum dot (QD) is a semiconductor crystallite small enough to show evidence of ‘quantum confinement.’ In this size regime, excitons generated within a crystallite are confined spatially by the crystallite's small dimensions. Various optical properties of a QD are size-dependent, therefore, and tunable provided that QDs of the desired size can be isolate. This property may be exploited in technologies leveraging the emissive properties of QDs—e.g., color displays, lighting, lasing—as well as technologies leveraging absorptive properties—photon detection, photovoltaic applications, etc. Tunability also may be exploited to make specialized electrooptical materials and/or components, such as light-emitting diodes and down-shifting color-convers

Although preparative methods various QD materials have been reported, purification of QD products remain a challenge. State-of-the-art QD purification typically involves a reprecipitation step, in which QD material dissolved in a relatively nonpolar solvent is precipitated by addition of a much larger volume of a miscible, more polar solvent. Reprecipitation adds significant expense to manufacturing-scale QD purification due to excessive solvent consumption and associated solvent disposal and/or recovery costs. Moreover, it difficult to integrate this type of purification into a continuous flow system. Other state-of-the-art QD purification methods include chromatography, which also consumes much solvent, and electrophoresis.

### SUMMARY

One disclosed example provides an ultrafiltration system for quantum-dot (QD) purification. The ultrafiltration system comprises a pump having a low-pressure side and a high-pressure side, size-exclusion membrane having a law-pressure side and a high-pressure side, and an inlet outlet arrangement. An inlet arranged on the high-pressure side of the size-exclusion membrane is coupled fluidically to the high-pressure side of the pump. A product-enriched outlet is arranged on the high-pressure side of the size-exclusion membrane, fluidically downstream of the inlet. A product-depleted outlet is arranged on the low-pressure side of the size-exclusion membrane.

Another disclosed example provides a continuous-flow system for quantum-dot (QD) preparation. The continuous-flow system comprises a QD-formation stage configured to release a QD solution based on an organic solvent, a pump having a low-pressure side and a high-pressure side, the low-pressure side of the pump arranged fluidically downstream of the QD formation stage, a size-exclusion membrane having a low-pressure side and a high-pressure side, and an inlet/outlet arrangement as described above.

Another disclosed example provides a method to prepare a purified quantum-dot (QD) solution, comprising admitting a QD solution based on organic solvent to a low-pressure side of a pump; pumping the QD solution from the low-pressure side of the pump to a high-pressure side of the pump; conducting the QD solution from the high-pressure side of the pump to an inlet on a high-pressure side of a size-exclusion membrane; flowing the QD solution across the high-pressure side of the size-exclusion membrane to an outlet; releasing a portion of the organic solvent from a low pressure side of the size-exclusion membrane; and collecting QD-enriched solution from the outlet.

This Summary is provided to introduce a selected part of this disclosure in simplified form, not to identify key or essential features. The claimed subject matter, defined by the claims, is limited neither to the content of the Summary nor to implementations that address the problems or disadvantages noted herein.

### BRIEF DESCRIPTION OF THE DRAWINGS

FIG. 1 shows aspects of an example QD preparation method.

FIG. 2 shows aspects of an example continuous-flow reactor system.

FIG. 3 illustrates aspects of an example method to purify a QD solution.

FIG. 4 schematically shows aspects of an example ultrafiltration stage of a continuous-flow reactor system.

FIG. 5 schematically shows aspects of an example purification stage of a continuous-flow reactor system.

### DETAILED DESCRIPTION

Aspects of this disclosure will now be described by example and with reference to the drawing figures listed above. Components, process steps, and other elements that may be substantially the same in one or more of the figures are identified coordinately and described with minimal repetition. It will be noted, however, that elements identified coordinately may also differ to some degree. It will be further noted that the figures are schematic and generally not drawn to scale. Rather, the various drawing scales, aspect ratios, and numbers of components shown in the figures may be purposely distorted to make certain features or relationships easier to see.

As noted above, reprecipitation, chromatography, and electrophoresis may be used to purify QD materials, but each technique presents certain issues. Reprecipitation is expensive due to the amount of solvent required, and is difficult to integrate into a continuous-flow reactor system. Chromatography and electrophoresis present an additional difficulty in that the QD material to be purified must be kept in solution, separated from free ligand for an extended period of time, which may result in ligand dissociation as the QD system attempts to regain equilibrium.

Disclosed herein is a QD purification technique that is both solvent-efficient and amenable to continuous-flow processing. In ultrafiltration (also called diafiltration or dialysis), a nanoparticle solution flows parallel to a porous, size-exclusion membrane. Maintaining the flowing solution at a high pressure encourages molecules and smaller particles (impurities, typically, in QD synthesis) to pass through the pores of the membrane, leaving a product-enriched and impurity-depleted solution on the high-pressure side. Ultrafiltration reduces purification and solvent usage relative to competing QD purification technologies and is readily integrated into a continuous-flow reactor system. Traditional diafiltration is limited, typically, to hydrophilic particle systems in aqueous solution but the ultrafiltration techniques described herein may achieve efficient QD purification in nonpolar organic solvents commonly used for ligand-shelled QDs.

To provide a better understanding of the type of QD material to which these methods apply, one example QD synthesis is described below. It will be understood however, that the synthetic techniques presented herein are not limited to the described QD material or preparation method, but may be applied to any other suitable QD material.

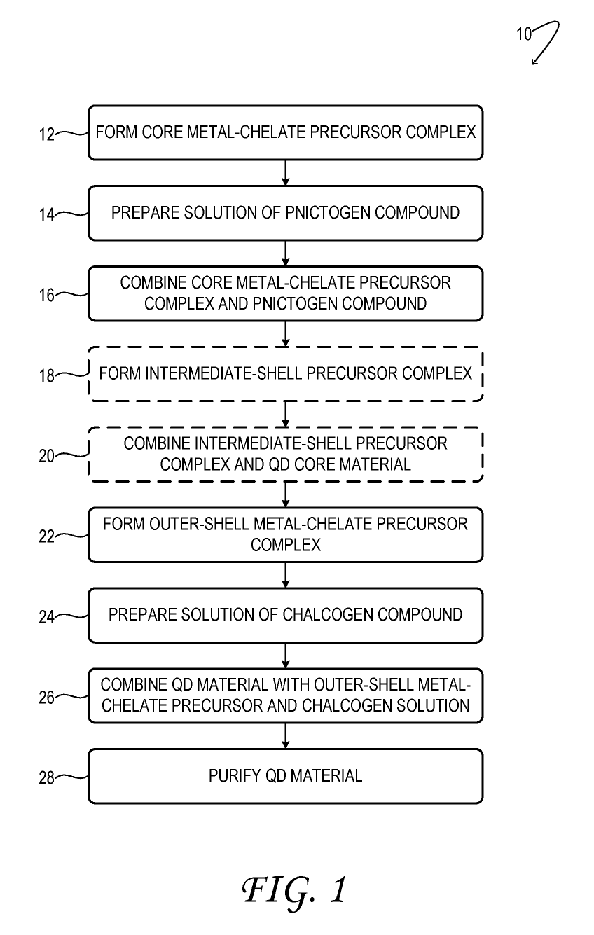

FIG. 1 illustrates aspects of an example QD preparation method 10. In this method are prepared shell-supporting, ligand-encapsulated QDs. The method is applicable, for example, to QDs having an InP core, a gallium phosphide (GaP) intermediate shell, and a ZnS outer shell. The particular conditions set forth below are appropriate for making red-emitting (λₘₐₓ at 630 mm) and green-emitting (λₘₐₓ at 530 nm) InP/GaP/ZnS core-shell-shell (CSS) QDs.

At 12, a core-forming metal-chelate precursor complex is formed. The core-forming metal-chelate precursor complex may be a chelate of a group IIIA metal ion (group-13 under IUPAC rules). The core-forming metal-chelate precursor complex may be a trivalent indium chelate, for example. To form the core-forming metal-chelate precursor complex a suitable metal salt—e.g., an anhydrous or hydrated form of indium acetate, indium nitrate, or indium chloride—is combined with oleic acid or another suitable ligand or ligand mixture. Suitable ligands include various carboxylic acids, amines, and imines, for example. The core-forming metal-chelate precursor complex may include, accordingly, one or more carboxylate complexes. Octanoate and oleate conjugate bases are believed to form a mixture of chelate-type coordination complexes with In³⁺ and other metals—e.g., In(O₂CR/O₂CR′)₃, with R═C₇H₁₅ and R′═C₁₇H₃₃. Oleate and octanoate function as stabilizing ligands during core growth, preventing aggregation and agglomeration of the growing QD cores. They also provide steric hindrance, which facilitates core-size control. In one example, octanoic and oleic acids may be used in a 1:1 molar ratio, and in excess relative to indium.

In sore examples, a divalent zinc carboxylate salt, such as zinc acetate dihydrate, may be incorporated into the core-forming metal-chelate precursor complex in an equimolar amount relative to trivalent indium. Zinc acetate is believed to enhance the PLQY of the final product as it ‘etches back’ the surface of the growing InP nanocrystal. Zinc acetate is believed to preferentially attack high energy centers, which may be defect sites. To reflect the fact that a non-stoichiometric amount of Zn may be incorporated onto the InP core, the designation ‘InZnP’ may be used in place of ‘InP’ in some examples.

Continuing in method 10, the reaction to form the core-forming metal-chelate precursor complex may be conducted at 110° C. in 1-octadecene solvent for a suitable time, for example two hours or more, under reduced pressure. Such conditions are believed to drive the equilibrium by volatilizing waters of hydration originating with hydrated forms of the indium salt (if any) well as the acetic, nitric, and/or hydrochloric acid by-products. In this manner, the original anions acetate, nitrate and/or chloride may be removed from the reaction system. High-boiling octanoic and oleic acids, however, remain in liquid form under the reaction conditions.

Separately, at 14, a solution of a pnictogen compound is prepared. The pnictogen compound may include an amine, phosphine, or arsine, for example. In some examples, the solution may be prepared in deoxygenated 1-octadecene or similar solvent. In one example, the pnictogen compound may include tris(trimethylsilyl) phosphine, P(Si(CH)₃)₃. The solution of the pnictogen compound may be made and stored under dry nitrogen.

At 16, at temperatures of about 230 to 250° C., the solution of the core-forming metal-chelate precursor complex is combined with the solution of the pnictogen compound to form a solution of QD core material, such as InP or InZnP. Reaction time may be controlled to provide QDs of the desired size and emission characteristics. Although the details provided herein appropriately describe the formation of InP cores, this aspect is by no means necessary. Other envisaged QD core materials include the III, V semiconductors indium nitride (InN), gallium nitride (GaN), GaP, and gallium arsenide (GaAs), for example.

Subsequently in method 10, an intermediate shell may be assembled upon the QD core The intermediate shell may perform various functions. First, the intermediate shell may passivate the surface of the QD core material. For example, an InP core may present dangling bonds, which may be trap sites for non-radiative recombination. A GaP intermediate shell may be used to passivate these dangling bonds, resulting in increased quantum efficiency for radiative recombination. Second, the intermediate shell may serve as an intermediary layer between the core and the outer shell of the QD. The lattice mismatch between InP and ZnS is about 8%, but the lattice mismatch between InP and GaP, and between GaP and ZnS, are only about 4% each. Better lattice matching reduces the number of interfacial defect sites, thereby increasing the PLQY. Accordingly, a suitable intermediate-shell precursor-forming salt—e.g., an anhydrous or hydrated form of gallium acetate, gallium nitrate, or gallium chloride—may be combined at 18 with a molar excess of an organic acid such as oleic acid. This forms an intermediate-shell precursor complex—e.g., Ga(O₂C—R′). The reaction may be accomplished at 110° C. for a suitable time period, for example, two hours, under reduced pressure, as described above for the analogous core-forming metal-chelate precursor complex.

At 20, the solution containing the intermediate-shell precursor complex is added to the solution containing the QD core, to form, for example, an InP/GaP QD system. This reaction may be accomplished at 175 to 300° C. for 15 to 60 minutes.

After the above transformation is complete, a ligand-terminated outer shell may be formed on each QD. To that end, an outer-shell-forming metal-chelate precursor complex is formed, at 22. The outer-shell-forming metal-chelate precursor complex may be a chelate of a group IIB metal ion (group-12 under IUPAC rules). The outer-shell-forming metal-chelate precursor complex may be a divalent zinc chelate, for example. To form the outer-shell-forming metal-chelate precursor complex, a suitable metal salt—e.g., zinc acetate, is combined with a slight molar excess of a carboxylic acid (oleic acid, for example).

Separately, at 24, a solution of one or more chalcogen compounds is prepared. Such chalcogen compounds may include thiols, disulfides, or selenols, for example. In one example, a mixed thiol or corresponding disulfide solution—e.g., 1-dodecanethiol and 1-hexanethiol (at any suitable ratio) may be combined with 1-octadecene as solvent. At 26, the outer-shell-forming metal-chelate precursor complex and the chalcogen compound solution are combined with the solution of QD core material to form the shelled QD product—InP/GaP/ZnS(Lₓ), for example, where L=1-dodecanethiolate and/or 1-hexanethiolate.

The above process yields a lipophilic core-shell-shell (CSS) QD material of nominal purity. In the case of InP/GaP/ZnS(Lₓ), the emission wavelength of the material ranges from 520 to 650 nm hen excited at 400 or 450 nm. Thermogravimetric analysis (TGA) shows the organic content—in the form of n-alkyl ligands stabilizing the QDs—to be 20 to 30% in some examples.

No aspect of the foregoing process is intended to be limiting in, any way, for numerous variations, additions, and omissions are contemplated as well. In some examples, for instance, a zinc selenide (ZnSe) outer shell may be used in place of the ZnS outer shell described above. In that event, corresponding selenols may be used at 24, in place of the thiols. In addition, the intermediate shell may not be necessary for all applications, as other strategies may be used to dangling bonds of a QD core or outer shell. In some examples, therefore steps 18 and 20 ref method 10 may be omitted, to yield a single-shelled product—e.g., InP/ZnS(Lₓ) or InP/ZnSe(Lₓ).

At 28 of method 10, the QD product may be further purified. In one example, QDs may be precipitated from 1-octadecene solution by addition of acetone. The solid QD material may be collected by filtration or by centrifugation, while supernate containing unreacted starting materials and other impurities may be discarded or recycled. The solid then may be washed with additional acetone and redissolved in a nonpolar solvent such as octadecene or n-hexane. This purification process may be repeated two to four times, or until the desired purity is achieved. Other modes of purification may include flocculation, liquid-liquid extraction, distillation, electrodeposition, size-selection chromatography, and/or ultrafiltration, as examples. Any or all of the above purification modes may be used in combination. In some examples, however, one mode may be used to the exclusion of the others.

In some examples, the steps above may be enacted via batch processing. In other examples, continuous-flow processing may be used. In yet other examples, at least some of the precursor solutions—e.g., In(O₂CR/O₂CR′)₃ and P(Si(CH₃)₃—may be premixed together prior to use in a continuous-flow cell processing method.

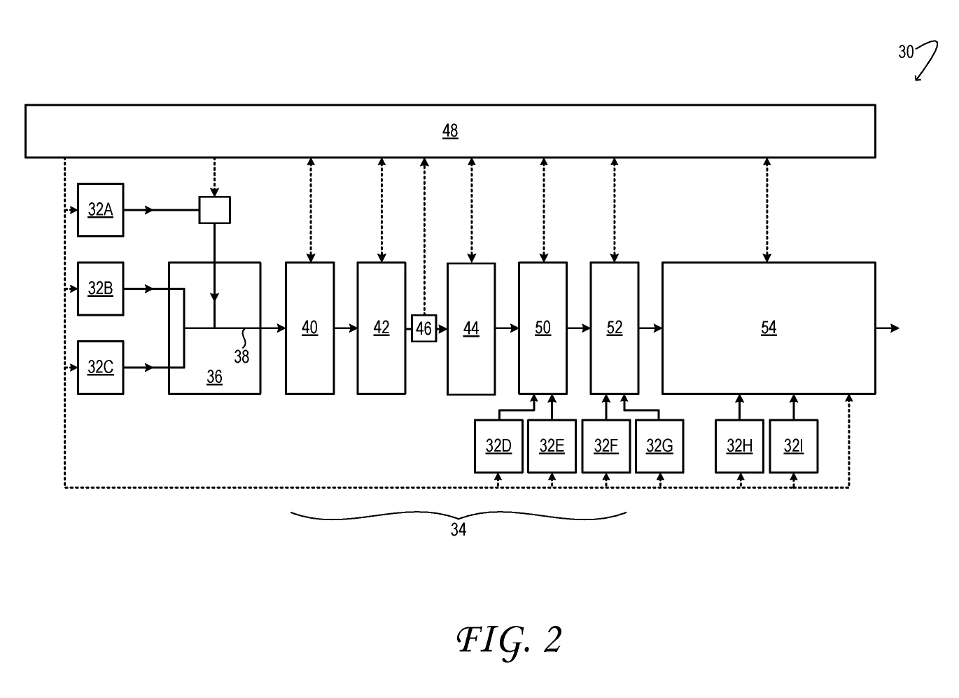

FIG. 2 shows aspects of an example continuous-flow reactor system 30. The continuous-flow reactor system includes a plurality of fluid sources 32, which may include compressed-gas cylinders, pumps, and/or liquid reservoirs, for example. The continuous-flow reactor system also includes a plurality of reaction devices 34 and a segmentation device 36. Taken together, the plurality of reaction devices 34 comprise a QD formation stage configured to release a QD solution based on an organic solvent. In the illustrated example, fluid sources 32A and 32B may provide, respectively, the core-forming metal-chelate precursor complex solution and the pnictogen compound solution.

Continuous-flow reactor system 30 includes a flow path for the reaction mixture comprising a primary conduit 38 that passes through the plurality of reaction devices 34. In segmentation device 36, an immiscible, non-reacting segmentation fluid (e.g., a relatively inert gas such as nitrogen, argon, or helium) is inserted into the flow path to provide segmented flow of the reaction mixture. The segmented flow provides a narrower distribution of residence times in downstream reaction devices than without segmentation.

From segmentation device 36, the segmented reaction mixture and immiscible segmentation fluid pass into energized activation stage 40, where the mixture is rapidly energized by an energy source—e.g., a monomodal, multimodal or multivariable frequency microwave source, a light source such as a high energy lamp or laser, a high temperature thermal (e.g., resistive heating) device, a sonicating device, or any suitable combination of energy sources. Here, the evolving QDs are rapidly and uniformly nucleated. Accordingly, method 10 above may further include thermally activating the combined core-forming metal-chelate precursor complex and pnictogen compound. The flow of the nucleated precursors then passes into incubation stage 42, where a heat source promotes growth of the nucleated precursors of the nanocrystalline core material under continuous-flow conditions. The process is quenched in collection stage 44, where the QD-containing solution may optionally be separated from the immiscible segmentation fluid. In other implementations, energized activation stage 40 may be omitted, as nucleation and growth may occur in a same reactor stage.

In the example of FIG. 2, analysis module 46 is arranged fluidically upstream of collection stage 44. In the analysis module, an assay may be conducted that tests one or more physical properties of the QDs emerging from incubation stage 42. In some examples, the analysis module may communicate with process controller 48. The process controller comprises an electronic control device operatively coupled to fluid sources 32 and to various inputs of reaction devices 34. Such inputs may include energy flux in energized activation stage 40, heating in incubation stage 42, and various flow-control componentry arranged throughout reactor 30. Closed-loop feedback based on the property or properties assayed in the analysis module may be used to automatically optimize or adjust QD size, composition, and/or other properties.

Continuing in FIG. 2, continuous-flow reactor system 30 includes an intermediate-shell fabrication stage 50 fluidically downstream of collection stage 44, and an outer-shell fabrication stage 52 fluidically downstream of the intermediate-shell fabrication stage. Reactor system 30 of FIG. 2 also includes a purification stage 54 arranged downstream of outer-shell fabrication stage 52. The structure and function of purification stage 50 may differ in the different implementations of this disclosure, as various modes of QD purification lie within its spirit and scope.

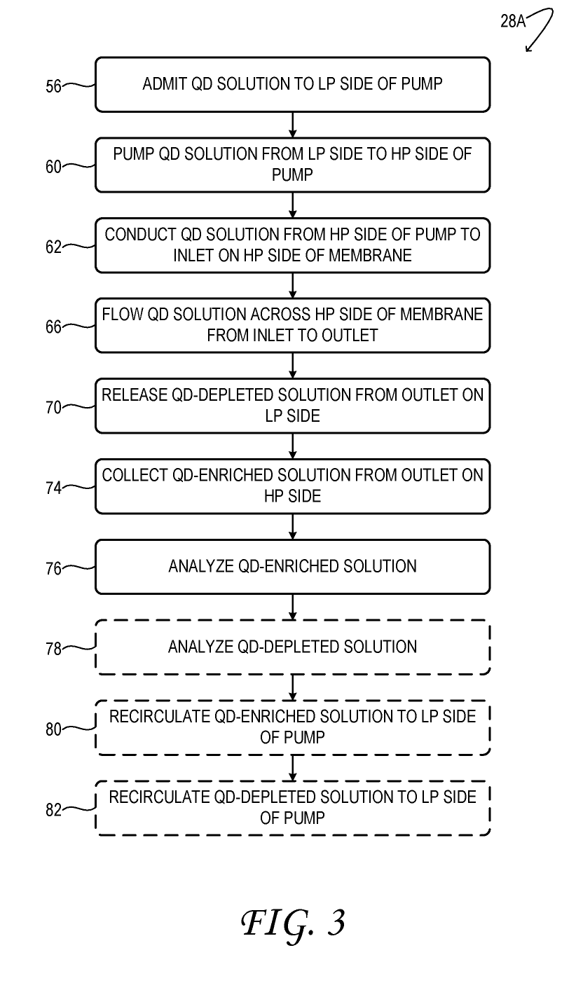

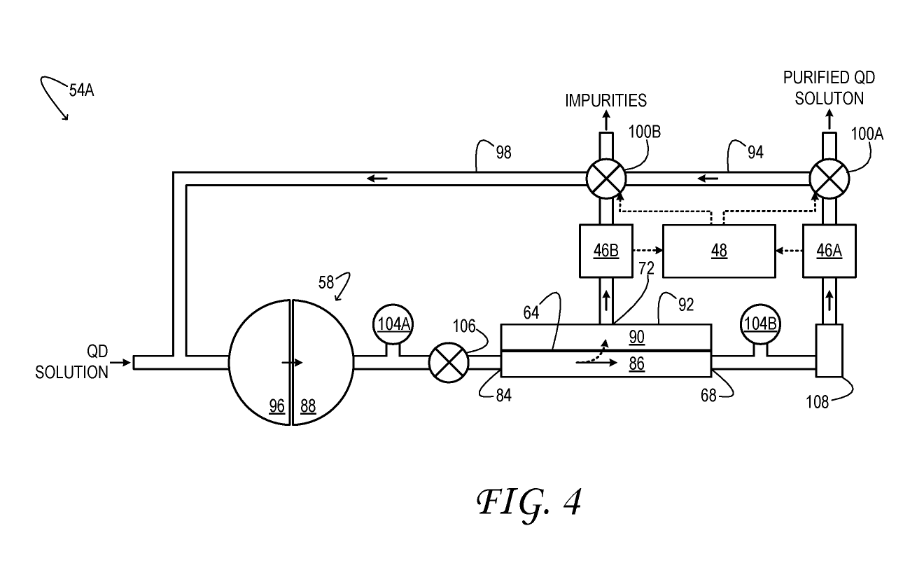

FIG. 3 illustrates aspects of an example method 28A for purifying a QD solution. Method 28A may be incorporated into method 10 of FIG. 1, as an example of purification step 28. Accordingly, method 10 as a whole may be viewed as a method to prepare a purified QD solution. In some implementations, method 28A may be combined with one or more of the purification approaches described in the context of method 10. In other implementations, method 28A may be enacted independently of method 10. In some implementations, method 28A may be enacted within a purification stage of a continuous-flow reactor system, such as ultrafiltration stage 54A of FIG. 4. Accordingly, method 28A will be described with reference to various components shown in FIG. 4.

In general, the QD solution purified in method 28A is a solution based on organic solvent. In other words, the QD material to be purified may be solvated primarily or exclusively by organic solvent. In some examples, organic solvent may be the major constituent by mass of the QD solution. In some examples, the QD solution may be substantially nonaqueous (e.g., anhydrous). In other examples, the QD solution may include at least some water in addition to organic solvent.

The organic solvent or solvent system on which the QD solution is based is particularly limited, provided that it effectively dissolves the QD material to be purified and at least some of the impurities to be removed. Such impurities may include precursor compounds, unreacted ligand, side products of the various QD-forming reactions (such as zinc sulfide), and/or QDs of undesirable size. Suitable organic solvents for the QD solution in method 28A include 1-octadecene, n-hexane or toluene.

At 56 of method 28A, an unpurified or pre-purified QD solution based on organic solvent is admitted to a low-pressure side of a pump (e.g., pump 58 of FIG. 4). At 60, the QD solution is pumped from the low-pressure side of the pump to a high-pressure side of the pump. At the high-pressure side of the pump, the QD solution may be pressurized to 100 to 150 pounds per square inch (PSI), for example. In one particular implementation, the QD solution may be pressurized to 125 PSI. In another implementation, lower pressures may be used, for example, pressures in the range of 50 to 100 PSI.

At 62 the QD solution is conducted from the high-pressure side of the pump to an inlet on a high-pressure side of a size-exclusion membrane (e.g., membrane 64 of FIG. 4). In one implementation, the QD solution may be conducted at a flow rate of 70 to 300 milliliters (ml) per minute. At 66 the QD solution is flown across the high-pressure side of the size-exclusion membrane to an outlet arranged on the high-pressure side (e.g., product-enriched outlet 68 of FIG. 4). As the QD solution flows from the inlet to the outlet, it is maintained under high pressure, which biases movement of small particles through the pores of the membrane to the low-pressure side of the membrane. However, since the pores of the membrane are small, only molecules and very small nanoparticles (impurities in QD synthesis) readily penetrate the membrane.

At 70 an impurity-enriched, product-depleted portion of the organic solvent is released from an outlet arranged on the low pressure side of the size-exclusion membrane (e.g., product-depleted outlet 72 of FIG. 4), At 74 product-enriched solution is collected from the outlet arranged on the high-pressure side of the membrane. In one implementation, the ratio of the volume of product-enriched solution collected to the volume of product-depleted solution released is 9:1.

At 76 the product-enriched solution is analyzed. Suitable analysis techniques may include photoluminescence, small-angle x-ray scattering, etc. At 78 the product-depleted solution released from the low-pressure side of the size-exclusion membrane is optionally analyzed.

At 80 the product-enriched solution is optionally recirculated to the low-pressure side of the pump for further purification. At 82 the product-depleted solution released from the low-pressure side of the size-exclusion membrane is optionally recirculated to the low-pressure side of the pump for further recovery of QD product. In some embodiments, recirculation of one or both product-enriched solution and the product-depleted solution is controlled in a closed-loop manner based on the analysis enacted at 76 and 78 of method 28A. For instance, the product-enriched solation may be recirculated if it is found to contain too much impurity. Conversely, the product-depleted solution may be recirculated if it is found to contain too much of the QD product. No aspect of method 28A is intended to be limiting, as numerous variations, extensions, and omissions to the above method steps are equally envisaged. In some implementations, for example, multiple stages of ultrafiltration may be used for additional purification.

FIG. 4 illustrates aspects of an example ultrafiltration stage 54A, a flow-system component for QD purification. Ultrafiltration stage 54A may be incorporated into continuous-flow reactor system 30 of FIG. 2, as an instance of purification stage 54. Accordingly, the continuous-flow reactor system as a whole may be viewed as a system for making a purified QD solution. In other implementations, ultrafiltration stage 54A may be combined with one or more of the other purification stages described above, or used independently.

Ultrafiltration stage 54A of FIG. 4 includes pump 58 and size-exclusion membrane 64. An inlet 84 arranged on high-pressure side 86 of the size-exclusion membrane is coupled fluidically to high-pressure side 88 of the pump. Product-enriched outlet 68 is arranged on the high-pressure side of the size-exclusion membrane, fluidically downstream of the inlet. Product-depleted outlet 72 is arranged on low-pressure side 90 of the size-exclusion membrane.

The detailed configuration of pump 58 is not particularly limited, provided that the wetted components of the pump are resistant to the solvent or solvent system flowing through ultrafiltration stage 54A. This condition may impose material constraints on the pump particularly when the solvent or solvent system includes an organic solvent. The pump may be a gear pump, piston pump, or peristaltic pump, for example. In other implementations, the pump may comprise a mechanism to pressurize not the QD solution itself, but a column of air or inert gas maintained above the QD solution, so as to force the QD solution into inlet 84.

Size-exclusion membrane 64 must be permeable to the solvent or solvent system flowing through the ultrafiltration stage. For efficient ultrafiltration of organic-solvent based solutions, the membrane may have limited hydrophilicity, therefore, so that adventitious moisture (from the solvent, atmosphere, etc.) does not become trapped in the pore structure and block the ingress of potentially hydrophobic organic solvents. Further, the size-exclusion membrane must be stable in the solvent or solvent system flowing through the ultrafiltration stage. In one implementation, the size-exclusion membrane may be stable in 1-octadecene solvent. More particularly, the size-exclusion membrane must not swell in the solvent or solvent system to such a degree as would narrow the pores to unusable dimensions. For membrane materials in which some degree of solvent swelling is expected, a larger initial pore size may be selected in anticipation of pore-size reduction due to swelling. In general, the final pore size distribution of the size-exclusion membrane may be such as to retain the desired QD product but allow molecules and particles smaller than the desired QD product to pass through. It will be noted that the size of a QD determines its emission wavelength. For instance, a blue-emitting QD may be approximately one nanometer in diameter, whereas a green-emitting QD may be approximately three nanometers in diameter. In some implementations, the size-exclusion membrane may have a pore size of about 200 nanometers prior to solvent swelling of the membrane (e.g., swelling in the 1-octadecene or in other solvent or solvent system). In some implementations, the size-exclusion membrane may be a fluoropolymer membrane. The size-exclusion membrane may include poly(vinylidenefluoride), for example. In a more particular implementation, the size-exclusion membrane may be a TRISEP flat sheet membrane TM10 (polyvinylidene fluoride (PVDF), pore size of 0.2 micron), available from TriSeP Corporation of Goleta, Calif. Membranes of different configurations may also be used.

In the embodiment shown in FIG. 4, size-exclusion membrane 64 is supported by pressure-tight enclosure 92, which also supports inlet 84, product-enriched outlet 68, and product-depleted outlet 72. The enclosure may confine approximately 50 milliliters of solution on either side of the size-exclusion membrane.

Ultrafiltration stage 54A of FIG. 4 also includes first and second analysis modules 46A and 46B. First analysis module 46A is configured to assess a property of fluid flowing from product-enriched outlet 68—e.g., a photoluminescence intensity, x-ray scattering profile, etc. Second analysis module 46B is configured to assess a property of fluid flowing from the product-depleted outlet.

Product-enriched recirculation loop 94 selectively couples the product-enriched outlet 68 to the pressure side 96 of pump 58. Product-depleted recirculation loop 98 selectively couples the product-depleted outlet 72 to the low-pressure side of the pump. However, the product-enriched solution from line 94 does not combine with product-depleted material from 46B. Rather, the product-enriched and product-depleted recirculation loops may each include an electronically actuable valve 100 (e.g., valve 100A, 100B) that opens and closes pursuant to control signal from process controller 48. The process controller may be include control logic to determine which, if any, of the outlet flows are to be recirculated back to the low-pressure side of the pump. Accordingly, the process controller may be operatively coupled to the first and second analysis modules. In the configuration shown in FIG. 4, ultrafiltration stage 54A also includes pressure-sensing componentry 104A and 104B, additional flow-control componentry 106, and pressure regulator 108 to keep the pressurized flow of the QD solution within desired operating parameters. In some implementations, an additional control valve may be arranged downstream or upstream of pressure-sensing componentry 104B.

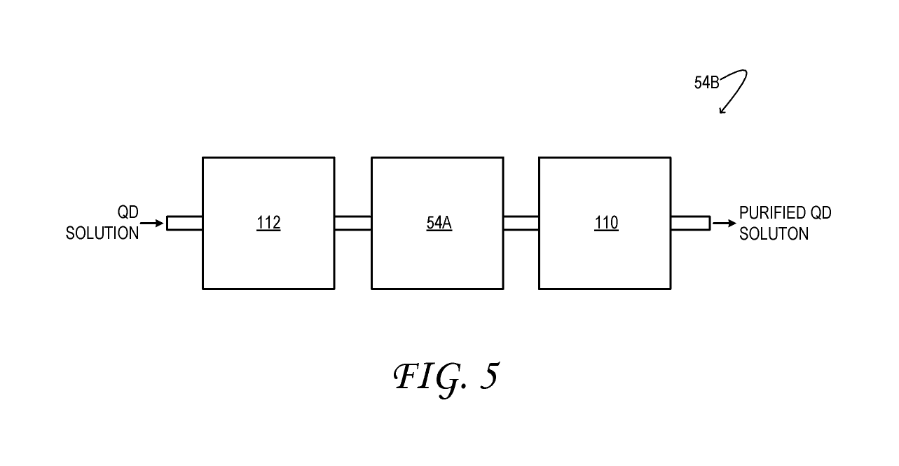

FIG. 5 shows another purification-stage configuration that may be incorporated into continuous-flow reactor system 30 of FIG. 2, as an instance of purification stage 54. Purification stage 54B includes an optional finishing purification stage 110 coupled fluidically downstream of the product-enriched outlet of ultrafiltration stage 54A. Purification stage 54B also includes an optional rough purification stage 112 coupled fluidically downstream of the QD formation stage of reactor system 30 and fluidically upstream of the low-pressure side of the pump of ultrafiltration stage 54A. In the embodiments envisaged herein, the rough purification stage may include a reprecipitation-and-centrifugation stage. The finishing stage may include one or more of an electrophoresis stage, a chromatographic stage, and a reprecipitation-and-centrifugation stage, for example.

It will be understood that the configurations and/or approaches described herein are presented for example, and that these specific examples or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of this disclosure includes all novel and nonobvious combinations and subcombinations of the various processes, systems and configurations, and other features, functions, acts, and/or properties disclosed herein as well as any and all equivalents thereof.

1. An ultrafiltration system for quantum-dot (QD) purification, the ultrafiltration system comprising:
a pump having a low-pressure side and a high-pressure side;
a size-exclusion membrane having a low-pressure side and a high-pressure side;
an inlet arranged on the high-pressure side of the size-exclusion membrane and coupled fluidically to the high-pressure side of the pump;
a product-enriched outlet arranged on the high-pressure side of the size-exclusion membrane, fluidically downstream of the inlet; and
a product-depleted outlet arranged on the low-pressure side of the size-exclusion membrane.

2. The ultrafiltration system of claim 1 further comprising an analysis module configured assess a property of fluid flowing from one or more of the product-enriched outlet and the product-depleted outlet.

3. The ultrafiltration system of claim 1 further comprising a product-enriched recirculation loop fluidically coupling the product-enriched outlet to the low-pressure side of the pump.

4. The ultrafiltration system of claim 1 further comprising a product-depleted recirculation loop fluidically coupling the product-depleted outlet to the low-pressure side of the pump.

5. The ultrafiltration system of claim 1 wherein the size-exclusion membrane is stable in 1-octadecene.

6. The ultrafiltration system of claim I wherein the size-exclusion membrane has a pore size of about 200 nanometers prior to solvent swelling of the membrane.

7. The ultrafiltration system of claim 1 wherein the size-exclusion membrane comprises a fluoropolymer membrane.

8. The ultrafiltration system of claim 1 wherein the size-exclusion membrane includes poly(vinylidenefluoride).

9. The ultrafiltration system of claim 1 further comprising an enclosure supporting the membrane, the inlet, the product-enriched outlet, and the product-depleted outlet.

10. A continuous-flow system for quantum-dot (QD) preparation, the continuous-flow system comprising:
a QD-formation stage configured to release a QD solution based on an organic solvent;
a pump having a low-pressure side and a high-pressure side, the low-pressure side of the pump arranged fluidically downstream of the QD formation stage;
a size-exclusion membrane having a low-pressure side and a high-pressure side;
an inlet arranged on the high-pressure side of the size-exclusion membrane and coupled fluidically to the high-pressure side of the pump;
a product-enriched outlet arranged on the high-pressure side of the size-exclusion membrane fluidically downstream of the inlet; and
a product-depleted outlet arranged on the low-pressure side of the size-exclusion membrane.

11. The continuous-flow system of claim 10 further comprising a finishing purification stage coupled fluidically downstream of the product-enriched outlet.

12. The continuous-flow system of claim 11 further comprising a rough purification stage coupled fluidically downstream of the QD formation stage and fluidically upstream of the low-pressure side of the pump.

13. The continuous-flow system of claim 12 wherein the rough purification stage includes a reprecipitation-and-centrifugation stage.

14. A method to prepare a purified quantum-dot (QD) solution, the method comprising:
admitting a QD solution based on organic solvent to a low-pressure side of a pump;
pumping the QD solution from the low-pressure side of the pump to a high-pressure side of the pump;
conducting the QD solution from the high-pressure side of the pump to an inlet on a high-pressure side of a size-exclusion membrane;
flowing the QD solution across the high-pressure side of the size-exclusion membrane to an outlet;
releasing a portion of the organic solvent from a low pressure side of the size-exclusion membrane; and
collecting QD-enriched solution from the outlet.

15. The method of claim 14 wherein the organic solvent is a substantially non-aqueous solvent.

16. The method of claim 14 wherein the organic solvent includes 1-octadecene.

17. The method claim 14 further comprising recirculating the QD-enriched solution to the low-pressure side of the pump.

18. The method of claim 14 further comprising recirculating the portion of the organic solvent released from the low-pressure side of the size-exclusion membrane to the low-pressure side of the pump.

19. The method of claim 14 further comprising analyzing one or both of the QD-enriched solution and the portion of the organic solvent released from the low-pressure side of the size-exclusion membrane.

20. The method of claim 19 wherein recirculation of one or both of the QD-enriched solution and the portion of the organic solvent released from the low-pressure side of the size-exclusion membrane is controlled in a closed-loop manner based on said analyzing.
